(19) United States
(12) Patent Application Publication
(10) Pub. No.: US 2011/0029855 A1
(43) Pub. Date: Feb. 3, 2011

(54) INFORMATION TERMINAL APPARATUS

(75) Inventor: Masanori MORITA, Fussa-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 12/783,045

(22) Filed: May 19, 2010

(30) Foreign Application Priority Data
Jul. 28, 2009 (JP) 2009-175272

(51) Int. Cl. G06F 17/00

(52) U.S. Cl. 715/233

(57) ABSTRACT

An information terminal apparatus includes: an electronic pen in which a sticky-note management table is stored, the sticky-note management table containing messages and pieces of sticky-note type information, the messages being respectively associated with the pieces of sticky-note type information, each piece of the sticky-note type information indicating a type of sticky-note image; and a terminal body that includes a display that displays an image, a terminal communicating section that acquires the sticky-note management table from the electronic pen, a management table storing section that stores the acquired sticky-note management table, a tablet that is operated with the use of the electronic pen, and a controlling section that reads the messages that are respectively associated with the pieces of sticky-note type information out of the sticky-note management table stored in the management table storing section and causes the display to display the read messages.

### BACKGROUND

1. Technical Field

The present invention relates to an information terminal apparatus that allows a user to electronically put, for example, a sticky-note image on an electronic document that is displayed on a display with the use of an electronic pen.

2. Related Art

An information terminal apparatus that is provided with a tablet for data input is known in the art. The tablet is provided on an electronic display medium such as a liquid crystal display device, electronic paper, or the like with its input surface being exposed. A user can input information by touching the input surface of the tablet with an electronic pen. The following technique is known as disclosed in JP-A-8-328736 (refer to FIG. 1 and paragraphs [0012] and [0013]), which can be used when such an information terminal apparatus is shared by a plurality of users. It is judged whether identification information that is outputted from an electronic pen agrees with identification information that is registered in a terminal body or not. If they agree, additional information that is associated with the registered identification information is displayed on a display.

However, the related art described above has a disadvantage in that it sometimes requires very cumbersome settings in the terminal body depending on how it is used.

### SUMMARY

An advantage of some aspects of the invention is to provide a technique for avoiding cumbersome settings in a terminal body.

In order to overcome the above disadvantages without any limitation thereto, an information terminal apparatus according to an aspect of the invention includes: an electronic pen in which a sticky-note management table is stored, the sticky-note management table containing messages and pieces of sticky-note type information, the messages being respectively associated with the pieces of sticky-note type information, each piece of the sticky-note type information indicating a type of sticky-note image; and a terminal body that includes a display that displays an image, a terminal communicating section that acquires the sticky-note management table from the electronic pen, a management table storing section that stores the acquired sticky-note management table, a tablet that is operated with the use of the electronic pen, and a controlling section that reads the messages that are respectively associated with the pieces of sticky-note type information out of the sticky-note management table stored in the management table storing section and causes the display to display the read messages when an operational instruction for electronically putting the sticky-note image on a document displayed on the display is issued from the electronic pen to the tablet. With the above features of an information terminal apparatus according to an aspect of the invention, the messages that are respectively associated with the pieces of sticky-note type information are acquired from the electronic pen. In addition, when an operational instruction for electronically putting the sticky-note image on a document displayed on the display is issued from the electronic pen, these messages are displayed. Therefore, it is not necessary at the terminal-body side to pre-memorize correspondences for the messages that are respectively associated with the pieces of sticky-note type information, which makes it possible to substantially simplify settings in the terminal body. Moreover, it is not necessary for users to memorize associated messages corresponding to an electronic pen (type) they use even when a set of messages for one electronic pen is different from a set of messages for another electronic pen or the other electronic pen.

### BRIEF DESCRIPTION OF THE DRAWINGS

The invention will be described with reference to the accompanying drawings, wherein like numbers reference like elements.

FIG. 1 is a diagram that schematically illustrates an example of the hardware configuration of an information terminal apparatus according to an exemplary embodiment of the invention.

FIG. 2 is a block diagram that schematically illustrates an example of the functional blocks of an information terminal apparatus according to an exemplary embodiment of the invention.

FIGS. 3A and 33 are a set of diagrams each of which schematically illustrates an example of the content of a sticky-note management table stored in an electronic pen according to an exemplary embodiment of the invention.

FIG. 4 is a diagram that schematically illustrates an example of the content of an icon table that is stored in a terminal body of an information terminal apparatus according to an exemplary embodiment of the invention.

FIG. 5 is a diagram that schematically illustrates an example of a picture displayed on the screen of a display that is provided on the terminal body according to an exemplary embodiment of the invention.

FIG. 6 is a diagram that schematically illustrates an example of the content of a coordinate management table that is stored in the terminal body according to an exemplary embodiment of the invention.

FIG. 7 is a flowchart that schematically illustrates an example of the operation of an information terminal apparatus according to an exemplary embodiment of the invention.

FIG. 8 is a flowchart that schematically illustrates an example of the operation of an information terminal apparatus according to an exemplary embodiment of the invention.

FIG. 9 is a diagram that schematically illustrates an example of a part of a picture displayed during the operation for electronically putting a sticky-note icon on a document according to an exemplary embodiment of the invention.

FIGS. 10A and 10B are a set of diagrams that schematically illustrates an example of a part of a picture displayed during the operation for electronically putting a sticky-note icon on a document according to an exemplary embodiment of the invention.

FIG. 11 is a diagram that schematically illustrates an example of a part of a picture displayed during the operation for electronically putting a sticky-note icon on a document according to an exemplary embodiment of the invention.

FIGS. 12A and 12B are a set of diagrams that that schematically illustrates an example of a part of a picture displayed during the operation for confirming a sticky-note icon electronically put on a document according to an exemplary embodiment of the invention.

### DESCRIPTION OF EXEMPLARY EMBODIMENTS

With reference to the accompanying drawings, an exemplary embodiment of the invention will now be explained. As explained in detail below, an information terminal apparatus according to the present embodiment of the invention is based on a technique for allowing a user to electronically put a sticky-note icon, which represents a sticky note, on an electronic document that is displayed on a display of a terminal body with the use of an electronic pen. In the description of this specification, the phrase “(electronically) put a sticky-note icon on a (electronic) document” does not mean the physical pasting of a sticky note on a document with the use of an adhesive or the like. It means the displaying of an image that corresponds to a sticky-note icon on an electronic document that is displayed on a display device or any other electronic display medium (collectively referred to as “display”) 24 as if the sticky note were physically put on the document.

There is more than one type of sticky-note icon. A message like an explanatory note is associated with each icon type. Therefore, when a user uses an electronic pen as a pointer to point to a sticky-note icon put on an electronic document, a message that is associated with the sticky-note icon is displayed. For example, the message appears as a pop-up message. By this means, a certain user can confirm the meaning of a sticky-note icon that was electronically put by another user on an electronic document, for example, a few days ago.

In such an electronic sticky note, there is a demand for sharing an electronic document among a plurality of groups with the use of a plurality (or plural types) of electronic pens each of which is given out to the corresponding one of the groups. In addition, there is a demand for making a set of messages that are respectively associated with a set of sticky-note icons for one group using one electronic pen (one pen type) different from a set of messages that are respectively associated with a set of sticky-note icons for another group using another electronic pen or for the other group using the other electronic pen. In other words, there is a demand for making a set of messages for one electronic pen different from a set of messages for another or the other electronic pen. For example, there is a case where a certain group desires to use a sticky-note icon “!” as an icon that means “Please make sure to acknowledge this comment” whereas another group desires to use the same sticky-note icon “!” as an icon that means “We need to iron out the differences of opinions on this issue”. When an electronic sticky note is used as described above, it is necessary for members belong to each group to know correspondence between each sticky-note icon and what the icon means as a common notation rule that is shared within the group. Besides the above necessity, there is a problem in that settings that have to be made at the terminal-body side are complex. An information terminal apparatus according to the present embodiment of the invention provides a solution to the above problem, though not limited thereto.

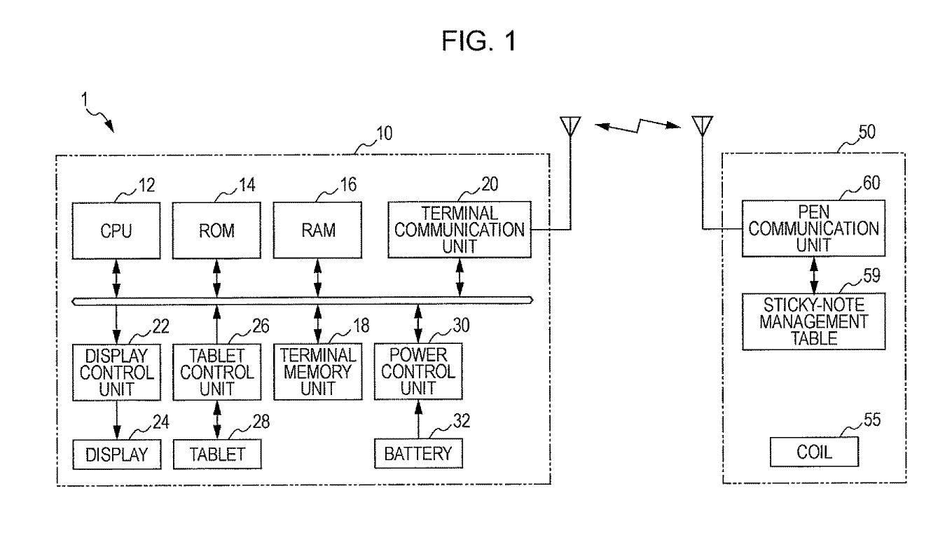

FIG. 1 is a diagram that schematically illustrates an example of the hardware configuration of an information terminal apparatus according to an exemplary embodiment of the invention. As illustrated in FIG. 1, an information terminal apparatus 1 includes a terminal body 10 and an electronic pen 50. The terminal body 10 includes a CPU 12, a ROM 14, a RAM 16, a terminal memory unit 18, a terminal communication unit 20, a display control unit 22, the display 24, a tablet control unit 26, a tablet 28, a power control unit 30, and a battery 32. The CPU 12 controls each component via a bus. In the present embodiment of the invention, the CPU 12 executes a sticky-note labeling/confirming program, which will be explained later, to control the content of display in accordance with inputting operation performed with the use of the electronic pen 50. The term “labeling” used herein means the putting of a sticky note on an electronic document. The ROM 14 stores BIOS (Basic Input Output System) and the like. The RAM 16 stores temporary data when the CPU 12 executes programs.

The terminal memory unit 18, which is a nonvolatile memory such as a flash memory, stores the sticky-note labeling/confirming program, an icon table, a coordinate management table, image data for sticky-note icons, and the like. The icon table and the coordinate management table will be explained later. The terminal communication unit 20 transmits various data to the electronic pen 50 and receives various data from the electronic pen 50. The display control unit 22 controls processing for drawing (i.e., displaying) a picture on the display 24 in accordance with instructions given by the CPU 12. The display 24 is a liquid crystal display device, electronic paper, or the like. The power control unit 30 performs control for turning the power of the terminal body 10 ON/OFF. In addition, the power control unit 30 manages the remaining power of the rechargeable battery 32.

The input surface of the tablet 28 is transparent. The input surface is the surface on which input operation is performed with the use of the electronic pen 50. The input surface of the tablet 28 is provided over the display surface of the display 24 at an observation side. Because the terminal body 10 has the above structure, a user can perform various input operations by tapping a picture that is displayed on the screen of the display 24 with the electronic pen 50, which means that the tip of the electronic pen 50 is knocked on the display screen lightly, or by moving the electronic pen 50 thereon in a tracing manner. On the basis of a detection signal sent from the tablet 28, the tablet control unit 26 generates an X, Y coordinate that corresponds to a location pointed with the use of the electronic pen 50. The tablet control unit 26 outputs the X, Y coordinate to the CPU 12.

In the present embodiment of the invention, the tablet 28 detects the coordinate of the location pointed by means of the electronic pen 50 by, for example, an electromagnetic induction method. Since coordinate detection performed by a tablet does not constitute the characteristic part of the present invention, its detailed explanation is omitted here. The following is a brief explanation of how the tablet 28 (the tablet control unit 26) detects the coordinate of a pointed location. A plurality of loop-type sensor coils for X-coordinate detection and a plurality of loop-type sensor coils for Y-coordinate detection are provided in the input surface of the tablet 28. On the other hand, a coil 55 is wound around an iron core at the tip part of the electronic pen 50. A capacitor that is not illustrated in the drawing is connected to the coil 55. When an alternating current is applied to the sensor coils, a magnetic field is generated on the input surface of the tablet 28. If the tip of the electronic pen 50 is present on the input surface, an induced current flows through the coil 55 of the electronic pen 50 in response to the generated magnetic field. As a result, electric charges are accumulated in the capacitor. Thereafter, when the application of the AC current to the loop-type sensor coils is stopped, the electric charges accumulated at the capacitor are discharged to flow through the coil 55 of the electronic pen 50 as an electric current, which generates a magnetic field. Due to the magnetic field, an induced current flows through a sensor coil that is located near the tip of the electronic pen 50. The position of the sensor coil through which the induced current flows is found (i.e., located) in the X coordinate system and the Y coordinate system. This position-finding operation is repeated, for example, a plurality of times in one second. By this means, it is possible for the tablet control unit 26 to judge whether there is the tip of the electronic pen 50 on the input surface of the tablet 28 or not. In addition, if the tip of the electronic pen 50 is present thereon, the tablet control unit 26 can find the X, Y coordinate that corresponds to the location pointed with the use of the electronic pen 50. Note that the detection method of the tablet 28 is not limited to an electromagnetic induction method. Any other method may be used as long as the coordinate of the electronic pen 50 can be detected.

The electronic pen 50 includes the coil 55, a sticky-note management table 59, and a pen communication unit 60. The sticky-note management table 59 is stored in a nonvolatile memory. A more detailed explanation of the sticky-note management table 59 will be given later. The pen communication unit 60 transmits various data to the terminal communication unit 20 and receives various data from the terminal communication unit 20. In the present embodiment of the invention, plural types of electronic pens are prepared. The type of electronic pens (or an electronic pen) given out to one group of users is different from the type of electronic pens given out to another group of users or the other group of users. Specifically, in the present embodiment of the invention, two types of electronic pens are prepared. To distinguish one of the two types of electronic pens from the other, reference numerals 50a and 50b are used in the following description and the accompanying drawings. The content of the sticky-note management table 59 of the electronic pen 50a is different from that of the electronic pen 50b. For this reason, identification information that is assigned to each type of electronic pens for the purpose of identifying the pen type is unique to its corresponding sticky-note management table. Where it is not necessary to distinguish one type of electronic pens from the other(s), an electronic pen is denoted simply as 50.

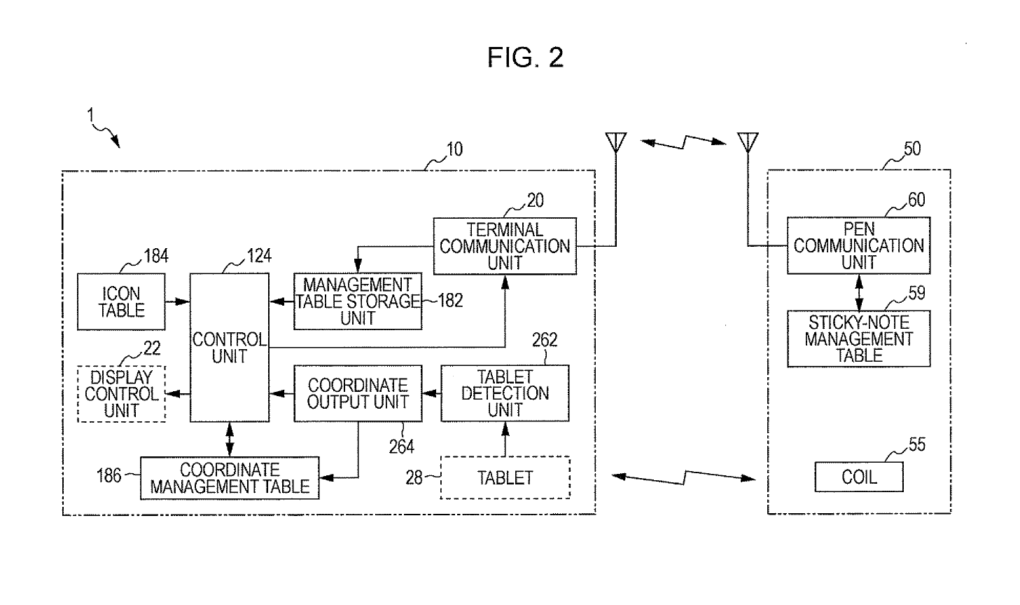

Next, an explanation is given of functional blocks that are built conceptually in the terminal body 10 in the above hardware configuration of the information terminal apparatus 1 when the sticky-note labeling/confirming program is executed. FIG. 2 is a block diagram that schematically illustrates an example of the functional blocks of an information terminal apparatus according to an exemplary embodiment of the invention. In FIG. 2, a control unit 124 of the terminal body 10 is a functional block that is built conceptually when the CPU 12 illustrated in FIG. 1 executes the above program. A tablet detection unit 262 and a coordinate output unit 264 constitute a combination of functional blocks that corresponds to the tablet control unit 26 illustrated in FIG. 1. A management table storage unit 182 is a memory area allocated in the terminal memory unit 18. An icon table 184 and a coordinate management table 186 are tables memorized in the terminal memory unit 18. The icon table 184 and the coordinate management table 186 are conceptually separated from each other on the basis of the content thereof.

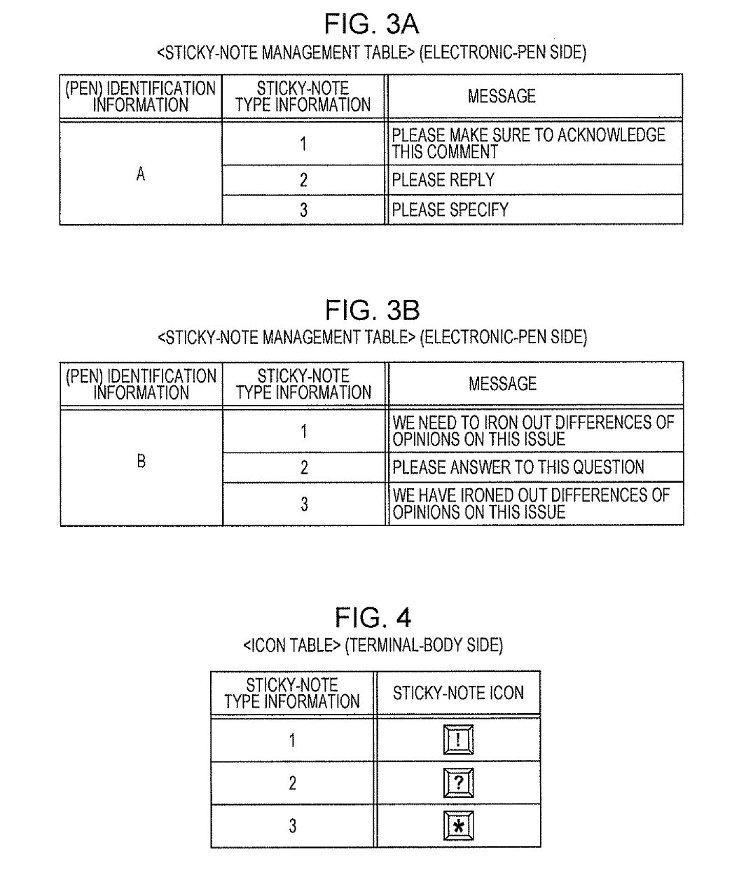

Next, the sticky-note management table 59 that is stored in the electronic pen 50 is explained. FIG. 3A is a diagram that schematically illustrates an example of the content of a sticky-note management table (59) stored in the electronic pen 50a. A message that specifies the meaning of a sticky note is associated with each of pieces of sticky-note type information “1”, “2”, and “3”. Besides the messages and the pieces of sticky-note type information, the sticky-note management table contains identification information “A”, which indicates the electronic pen 50a in which this sticky-note management table is stored. FIG. 3B is a diagram that schematically illustrates an example of the content of a sticky-note management table (59) stored in the electronic pen 50b. As in the above sticky-note management table stored in the electronic pen 50a, a message that specifies the meaning of a sticky note is associated with each of pieces of sticky-note type information “1”, “2”, and “3”. Besides the messages and the pieces of sticky-note type information, the sticky-note management table contains identification information “B”, which indicates the electronic pen 50b in which this sticky-note management table is stored. As illustrated in FIGS. 3A and 3B, in the present embodiment of the invention, a set of messages that are respectively associated with the pieces of sticky-note type information “1”, “2”, and “3” contained in the sticky-note management table stored in the electronic pen 50a is different from a set of messages that are respectively associated with the pieces of sticky-note type information “1”, “2”, and “3” contained in the sticky-note management table stored in the electronic pen 50b. In the example illustrated in FIGS. 3A and 3B, each of the messages that are respectively associated with the pieces of sticky-note type information “1”, “2”, and “3” in the table of the electronic pen 50a is different from the corresponding one of the messages that are respectively associated with the pieces of sticky-note type information “1”, “2”, and “3” in the table of the electronic pen 50b. However, the content of the tables is not limited to the illustrated example. It may be only a part of the message set contained in the table of the electronic pen 50a that is different from the corresponding part of the message set contained in the table of the electronic pen 50b.

Next, the icon table 184 and the coordinate management table 186 that are stored in the terminal body 10 are explained below. FIG. 4 is a diagram that schematically illustrates an example of the content of the icon table 184. As illustrated in FIG. 4, image data that represents a sticky-note icon is associated with each of the pieces of sticky-note type information “1”, “2”, and “3”.

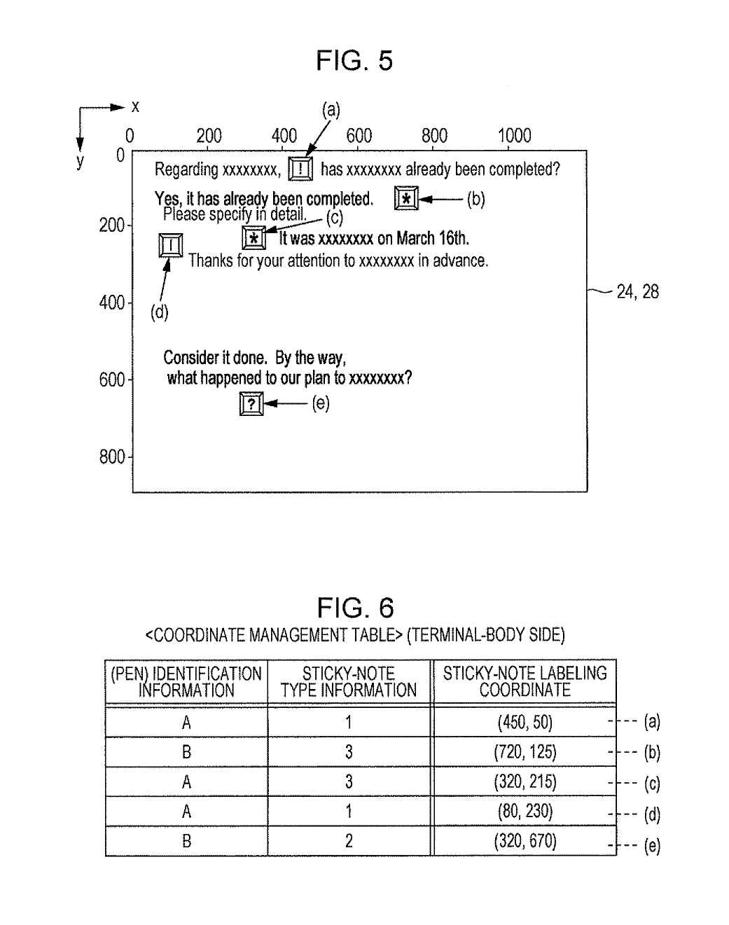

FIG. 5 is a diagram that schematically illustrates an example of a picture displayed on the screen of the display 24 in an information terminal apparatus according to the present embodiment of the invention. In the illustrated example of FIG. 5, sticky-note icons (a), (b), (c), (d), and (e) are displayed on an electronic document. FIG. 5 shows an example of text inputted by a plurality of users. In this example, the font of text inputted with the use of one electronic pen (type) is made different from the font of text inputted with the use of the other electronic pen to make it possible to distinguish the one electronic pen used for text input (i.e., group) from the other. Each of numerals that are shown outside the picture frame of the display 24 in FIG. 5 is a rough measure for X, Y coordinate. These numerals are shown for the purpose of explanation only. FIG. 6 is a diagram that schematically illustrates an example of the content of the coordinate management table 186 corresponding to the display example of FIG. 5. The illustrated coordinate management table 186 contains a set of sticky-note labeling coordinates, a set of sticky-note type information, and a set of pen identification information in association with one another. The sticky-note labeling coordinate is the coordinate of a location at which a sticky-note icon is put (i.e., labeled) electronically on an electronic document that is displayed on the display 24. The sticky-note type information indicates the type of the sticky-note icon. The pen identification information is ID information for identifying an electronic pen that was used for instructing that the sticky-note icon should be put electronically on the electronic document. Since processing for displaying text as illustrated in FIG. 5 is not relevant to the essential part of the present invention, its explanation is omitted here. The creation of a coordinate management table (recording of data) as illustrated in FIG. 6 will be explained later.

Next, operation that is performed when the sticky-note labeling/confirming program is executed in the terminal body 10 is explained. When the sticky-note labeling/confirming program is executed, it is assumed that an electronic document has already been displayed on the display 24 as illustrated in FIG. 5 as commanded by other program.

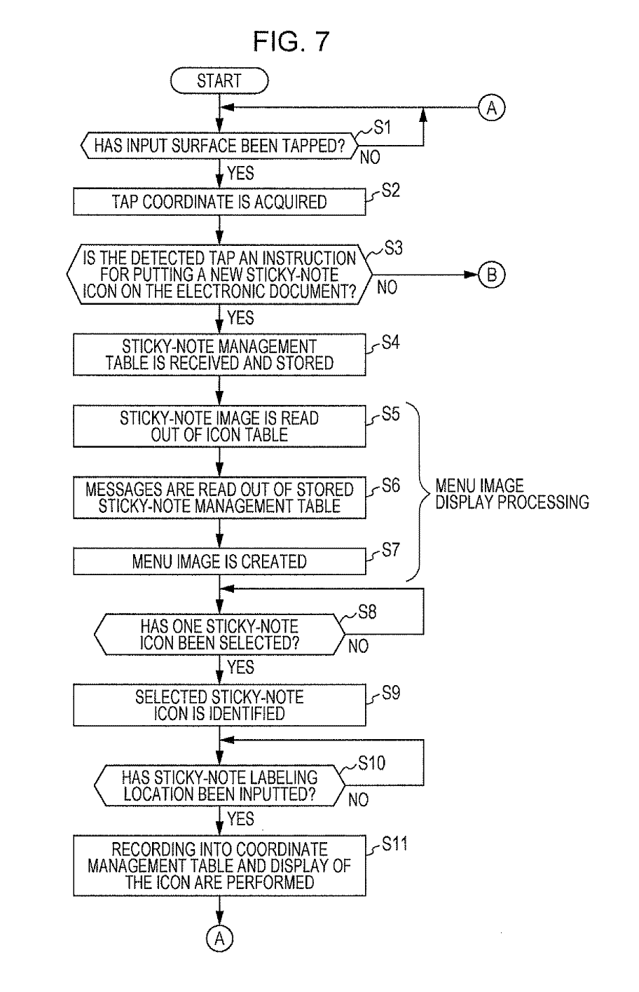

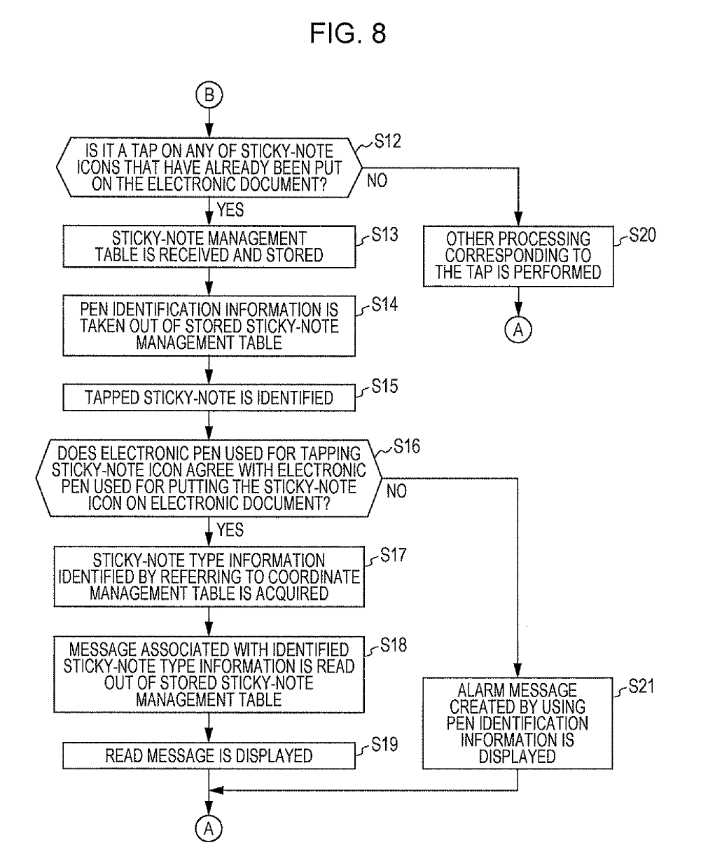

Each of FIGS. 7 and 8 is a flowchart that schematically illustrates the operation of an information terminal apparatus according to an exemplary embodiment of the invention. In a step S1, the control unit 124 judges whether the input surface of the tablet 28 has been tapped or not, which means that the tip of the electronic pen 50 is knocked against the surface lightly or not. Upon the detection of tapping with the electronic pen 50, the tablet detection unit 262 outputs the coordinate of a tapped location on the input surface of the tablet 28. The coordinate output unit 264 converts the coordinate of the tapped location into a display coordinate of the display 24. The coordinate output unit 264 supplies the converted coordinate to the control unit 124. Therefore, the control unit 124 judges that the input surface of the tablet 28 has been tapped if the converted coordinate is supplied from the coordinate output unit 264. It is judged that the input surface of the tablet 28 has not been tapped if no converted coordinate is supplied from the coordinate output unit 264. If it is judged that there is no tap, the control unit 124 returns the process to the step S1. Since the step S1 is repeated as a loop when there is no tap, subsequent steps are not performed. If it is judged that there is a tap, the control unit 124 acquires the coordinate of the tapped location from the coordinate output unit 264 in the step S2.

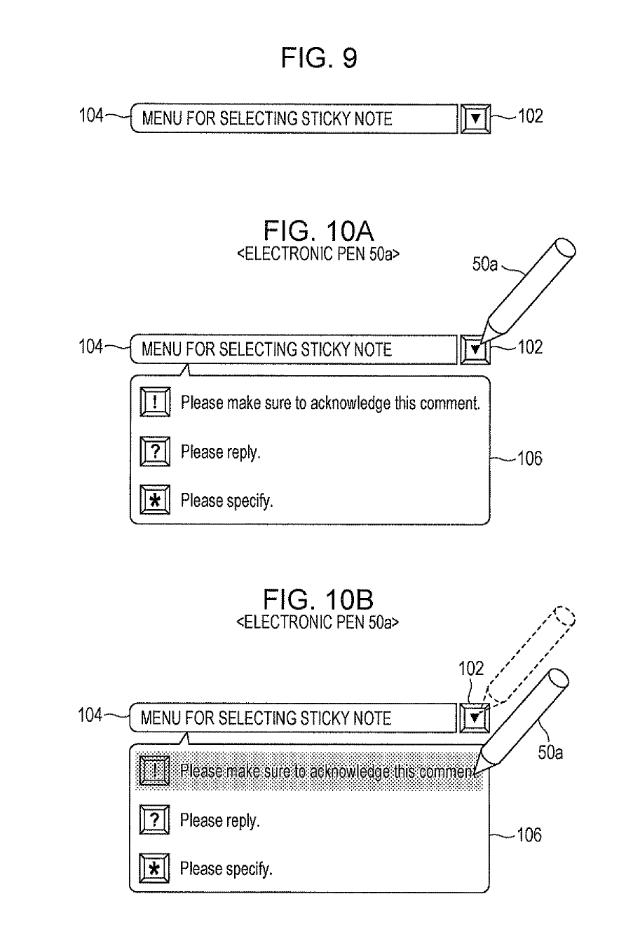

Next, in a step S3, the control unit 124 judges whether the detected tapping operation is an operational instruction for putting a new sticky-note icon, which is none of sticky-note icons that have already been put on an electronic document, on the electronic document or not. Specifically, as a preparation step for the above judgment, the control unit 124 causes a menu button 102 illustrated in FIG. 9 and a title bar 104, which shows the meaning of the menu, to be displayed at, for example, the upper part of a picture displayed on the screen of the display 24. In the next step, that is, in the judgment step, the control unit 124 judges that the detected tapping operation is an operational instruction for putting a new sticky-note icon on the electronic document if the converted coordinate of the tapped position is located inside the area of the display coordinate of the menu button 102. In this case, the process proceeds to a step S4. If the converted coordinate of the tapped position is not located inside the area of the display coordinate of the menu button 102, the control unit 124 judges that the detected tapping operation is not an operational instruction for putting a new sticky-note icon on the electronic document. In this case, the process skips to a step S12.

If it is judged that the detected tapping operation is an operational instruction for putting a new sticky-note icon on the electronic document, in the step S4, the control unit 124 acquires the sticky-note management table 59 from the electronic pen used for the tapping operation. In this step, the sticky-note management table 59 is stored into the management table storage unit 182. Specifically, as a first step of the above table-acquisition operation, the control unit 124 causes the terminal communication unit 20 to issue a request for a table (59), which is sent to the pen communication unit 60. In response to the table request, the sticky-note management table 59 is read out. The pen communication unit 60 sends the sticky-note management table 59 to the terminal communication unit 20 as a reply. Then, the control unit 124 causes the terminal communication unit 20, which has now received the sticky-note management table 59, to store the sticky-note management table 59 into the management table storage unit 182.

In steps S5, S6, and S7, the control unit 124 performs menu image display processing. Specifically, in the step S5, the control unit 124 looks up the icon table 184 (refer to FIG. 4) to identify a sticky-note icon that is associated with each of the pieces of sticky-note type information “1”, “2”, and “3” and then reads image data that represents each of the sticky-note icons out of the icon table 184. In the step S6, the control unit 124 reads each message that is associated with the corresponding sticky-note type information “1”, “2”, “3” out of the sticky-note management table 59 stored in the management table storage unit 182. Then, in the step S7, the control unit 124 creates a menu image that will be shown as a pull-down menu that contains the following list of sticky-note icons and messages and then sends the menu image to the display control unit 22. A sticky-note icon and a message each of which is associated with the sticky-note type information “1” are arranged at the first line (i.e., row) of the list. A sticky-note icon and a message each of which is associated with the sticky-note type information “2” are arranged at the second line of the list. A sticky-note icon and a message each of which is associated with the sticky-note type information “3” are arranged at the third line of the list. Containing the above list, the menu image created by the control unit 124 is shown as a pull down from the title bar 104. To display the above pull-down menu, the control unit 124 sends the menu image to the display control unit 22. The display control unit 22 controls the display 24 to display the menu. In this way, the menu list appears on the display 24.

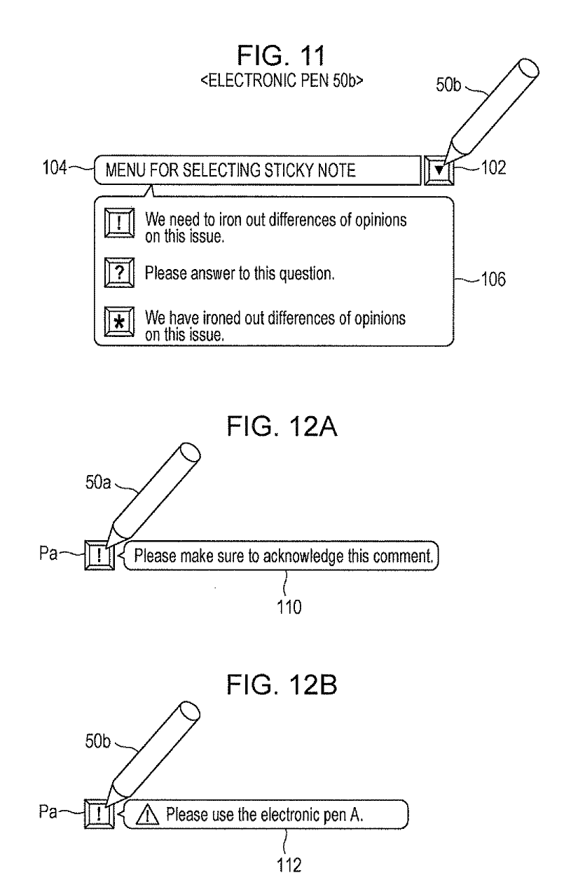

FIG. 10A is a diagram that schematically illustrates an example of an image containing a menu list that is displayed when the menu button 102 is tapped with the use of the electronic pen 50a. If it is assumed that the sticky-note management table stored in the electronic pen 50a has the content shown in FIG. 3A and that the icon table has the content shown in FIG. 4, as illustrated in FIG. 10A, the first line of the menu image 106 includes the sticky-note icon that is associated with the sticky-note type information “1” and the message “Please make sure to acknowledge (or confirm) this (comment)”. Under the same assumption, the second line of the menu image 106 includes the sticky-note icon that is associated with the sticky-note type information “2” and the message “Please reply”. The third line of the menu image 106 includes the sticky-note icon that is associated with the sticky-note type information “3” and the message “Please specify”. When the menu button 102 is tapped with the use of not the electronic pen 50a but the electronic pen 50b, as illustrated in FIG. 11, the messages contained in the sticky-note management table stored in the electronic pen 50b (refer to FIG. 3B) appear as the messages respectively associated with the pieces of sticky-note type information “1”, “2”, and “3” in the menu image 106.

After the displaying of the menu image 106 on the display 24, in a step S8, the control unit 124 judges whether operation for selecting one sticky-note icon (or one message) in the menu image has been performed or not. For example, the control unit 124 judges whether any of the area of the first line, the area of the second line, and the area of the third line in the menu image displayed on the display 24 has been tapped or not. The judgment processing can be performed as follows; when a converted coordinate is outputted from the coordinate output unit 264, the control unit 124 judges whether the converted coordinate is located inside any of the first line area, the second line area, and the third line area or not. If the control unit 124 judges that operation for selecting one sticky-note icon has not been performed, the process returns to the step S8. Therefore, if it is judged that operation for selecting one sticky-note icon has not been performed after the displaying of the menu image 106, the selection is waited for in a standby state in the step S8. If it is judged that operation for selecting one sticky-note icon has been performed, the process proceeds to a step S9. In the step S9, the control unit 124 identifies the selected sticky-note icon. For example, if the first line of the menu image 106 has been tapped as illustrated in FIG. 10B, the control unit 124 judges that the sticky-note icon that is associated with the sticky-note type information “1” has been selected.

Next, in a step S10, the control unit 124 judges whether a location at which the selected sticky-note icon should be put on the electronic document has been specified by means of the electronic pen or not. Specifically, the control unit 124 judges whether a converted coordinate has been outputted from the coordinate output unit 264 or not. The control unit 124 repeats the step S10 until a location at which the selected sticky-note icon should be put on the electronic document is specified. Upon the specification of the location, the process proceeds to a step S11 in which processing for additive recording into the coordinate management table 186 and for additive display of the sticky-note icon on the display 24 are performed. Specifically, in the step S11, the control unit 124 records pen identification information memorized in the management table storage unit 182, information on the type of the selected sticky-note icon, and the specified coordinate into the coordinate management table 186 as a set of new record data. Since this pen identification information was acquired from the electronic pen used for the tapping operation performed in the step S1, it indicates the electronic pen used for instructing the selection of the sticky-note icon and the putting thereof on the electronic document. In addition, the control unit 124 sends image data that represents the sticky-note icon that is associated with the sticky-note type information, that is, image data for the selected sticky-note icon, to the display control unit 22. The control unit 124 instructs the display control unit 22 to display the sticky-note icon at the specified coordinate as an additional icon for overwriting display. Alternatively, the control unit 124 instructs the display control unit 22 to display the sticky-note icon at the specified coordinate as an icon superimposed on a different layer. In this way, the sticky-note icon is displayed on the display 24 as instructed by the control unit 124. After the completion of the above processing in the step S11, the control unit 124 returns the process to the step S1 in wait for the next tapping operation.

As explained above, in the steps S1 to S7, when tapping operation for instructing that a new sticky-note icon should be put on an electronic document is performed, its sticky-note management table is acquired from an electronic pen used for the tapping operation. Then, messages that are respectively associated with pieces of sticky-note type information are displayed. Therefore, it is not necessary at the terminal body 10 to memorize correspondences between sticky-note images and messages. For this reason, even when more than one electronic pen is used, it is not necessary to memorize correspondences between sticky-note images and messages for each electronic pen (or for each identification information), which makes it possible to avoid cumbersome settings in a terminal body.

In the present embodiment of the invention, sticky-note images are stored in the icon table 184 of the terminal body 10. Sticky-note images that are associated with sticky-note type information contained in a sticky-note management table acquired from an electronic pen are read out of the icon table for display. Since it is not necessary for the sticky-note management table to contain any image data, it is possible to reduce the memory capacity of an electronic pen and reduce the amount of data that needs to be transmitted from the electronic pen to a terminal body. Moreover, when tapping operation for instructing that a new sticky-note icon should be put on an electronic document is performed, sticky-note images corresponding to pieces of sticky-note type information and associated messages are displayed in combination. Therefore, it is not necessary for users to memorize associated messages corresponding to an electronic pen (type) they use. Nor is it necessary for them to memorize correspondences between sticky-note images and messages.

Furthermore, when tapping operation for instructing that a new sticky-note icon should be put on an electronic document is performed, and when the type of the sticky-note icon and a location at which the sticky-note icon should be put on the electronic document are specified thereafter, in addition to the displaying of the sticky-note icon on a display as instructed, identification information for identifying an electronic pen (a sticky-note management table) that was used for the operation, sticky-note type information that indicates the type of the sticky-note icon, and a sticky-note labeling coordinate are recorded into a coordinate management table in association with one another. Therefore, when the sticky-note icon that has been put on the electronic document is tapped later, it is possible to obtain information such as one for identifying the electronic pen used for putting it on the electronic document by looking up the coordinate management table and perform processing in accordance with the information. The above processing for obtaining information corresponds to steps S12 to S21, more particularly, to steps S19 and S21.

Next, a series of processing steps that starts at the step S12 is explained below. If it is judged in the aforementioned step S3 that the detected tapping operation is not an operational instruction for putting a new sticky-note icon on the electronic document, the process jumps to a processing branch that starts at the step S12. In the step S12, the control unit 124 judges whether the detected tap is a tap on any of sticky-note icons that have already been put on the electronic document or not. Specifically, the control unit 124 judges whether the converted coordinate of the detected tap is included in coordinates (icon areas) recorded in the coordinate management table 186 (refer to FIG. 6) or not. If the result of the judgment in the step S12 is NO, it means that the tap detected in the step S1 is neither an operational instruction for putting a new sticky-note icon on the electronic document nor a tap on any of sticky-note icons that have already been put on the electronic document. In this case, the control unit 124 performs other processing corresponding to the tap in a step S20 and then returns the process to the step S1. If the result of the judgment in the step S12 is YES, as done in the step S4 explained earlier, the control unit 124 acquires the sticky-note management table 59 from the electronic pen used for tapping the sticky-note icon in a step S13. In this step, the sticky-note management table 59 is stored into the management table storage unit 182.

Next, in a step S14, the control unit 124 takes pen type information (pen identification information) out of the sticky-note management table 59 stored in the management table storage unit 182. In a step S15, the control unit 124 refers to the record of the coordinate management table 186 to identify pen identification information and sticky-note type information for the tapped sticky-note icon by using the converted coordinate of the detected tap as an index. Then, the control unit 124 judges whether the pen identification information acquired in the step S14 agrees with the pen identification information identified in the step S15 or not (step S16). Herein, the pen identification information acquired in the step S14 is information that identifies the electronic pen used for tapping the sticky-note icon that has already been put on the electronic document. The pen identification information identified in the step S15 is information that identifies the electronic pen used for instructing that the sticky-note icon should be put thereon. Therefore, it is judged in the step S16 whether or not the identification information assigned to the electronic pen used for tapping the sticky-note icon agrees with the identification information assigned to the electronic pen used for instructing that the sticky-note icon should be put thereon.

If they agree, in a step S17, the control unit 124 acquires the sticky-note type information identified by making reference to the record of the coordinate management table 186. Next, in a step S18, the control unit 124 reads the message that is associated with the identified sticky-note type information out of the sticky-note management table 59 stored in the management table storage unit 182. Then, in a step S19, the control unit 124 instructs the display control unit 22 to display the read message near the tapped sticky-note icon, for example, as a pop-up message. As a result, for example, display illustrated in FIG. 12A appears on the display 24. The display illustrated in FIG. 12A shows an exemplary case where, when a sticky-note icon Pa that corresponds to the sticky-note type information “1” has already been electronically put on a document with the use of the electronic pen 50a, the sticky-note icon Pa is tapped with the electronic pen 50a. This example shows that a message 110 that is associated with the sticky-note type information “1”, that is, “Please make sure to acknowledge this comment”, is displayed.

If it is judged in the step S16 that the pen identification information acquired in the step S14 does not agree with the pen identification information identified in the step S15, the control unit 124 instructs the display control unit 22 to display a pop-up alarm message in a step S21. The pen identification information identified by making reference to the record of the coordinate management table 186 is used for creating the alarm message. As a result, for example, display illustrated in FIG. 12B appears on the display 24. The display illustrated in FIG. 12B shows an exemplary case where, when the sticky-note icon Pa has already been electronically put on a document with the use of the electronic pen 50a, the sticky-note icon Pa is tapped with the electronic pen 50b. This example shows the appearance of an alarm message 112, which alerts a user to use the electronic pen 50a, that is, the electronic pen that was used when the sticky-note icon Pa was electronically put on the document, instead of using the electronic pen 50b. After the completion of the above processing in the step S19 or the step S21, the control unit 124 returns the process to the step S1 in wait for the next tapping operation.

As explained above, in the steps S1 to S3 and S12 to S19, when any of sticky-note icons that have already been put on the electronic document is tapped, processing for judging whether or not the identification information assigned to the electronic pen used for tapping the sticky-note icon agrees with the identification information assigned to the electronic pen used for instructing that the sticky-note icon should be put thereon is performed. Therefore, when a single electronic document is shared among a plurality of groups, it is possible for a user who taps any of sticky-note icons that have already been put on the electronic document with an electronic pen given out to the user belonging to one group to judge whether the sticky-note icon was put thereon with an electronic pen given out to the same group or the sticky-note icon was put thereon with an electronic pen given out to another group or the other group.

When any of sticky-note icons that have already been put on the electronic document is tapped with an electronic pen given out to one group, an alarm message such as one illustrated in FIG. 12B appears on the display screen if the tapped sticky-note icon was put thereon with an electronic pen given out to another group or the other group. This makes it possible not only to avoid the misunderstanding of the meaning of the sticky-note icon but also to inform the user that the sticky-note icon was put on the electronic document for the purpose of getting a message across to members who belong to another group or the other group, which means that it is irrelevant to the user.

When any of sticky-note icons that have already been put on the electronic document is tapped with an electronic pen given out to one group, as illustrated in FIG. 12A, a message appears on the display screen near the tapped sticky-note icon as a related message if the tapped sticky-note icon was put thereon with an electronic pen given out to the same group. Therefore, the members of the group can correctly understand the meaning of the sticky-note icon.

In the foregoing embodiment of the invention, two types of electronic pens, 50a and 50b, are used. Needless to say, however, three or more types of electronic pens may be used. Pen identification information is used to distinguish them from one another. When three or more types of electronic pens are used, sticky-note management tables whose content differs depending on the electronic pen type, for example, tables including those illustrated in FIG. 3A and FIG. 3B, are stored in the electronic pens. In the foregoing embodiment of the invention, it is explained that messages that are respectively associated with pieces of sticky-note type information “1”, “2”, and “3”, which are the same as those contained in the icon table 184, are memorized in the sticky-note management table 59 stored in an electronic pen. However, the scope of the invention is not limited to such an example. Messages that are memorized in the sticky-note management table 59 may be respectively associated with pieces of sticky-note type information that correspond to not all but some pieces of sticky-note type information contained in the icon table 184. For example, a message that is associated with sticky-note type information “1” and a message that is associated with sticky-note type information “3” only may be memorized in the sticky-note management table 59. As another modification example, a plurality of sticky-note management tables may be stored in an electronic pen. In the modified configuration, a table-switching mechanism such as a switch is used to select one among the plurality of sticky-note management tables. In this modified configuration, identification information does no longer have the meaning of information for identifying an electronic pen. It merely has the meaning of information for identifying a selected sticky-note management table.

In the foregoing embodiment of the invention, it is explained that, in a case where the electronic pen used for tapping the sticky-note icon does not agree with the electronic pen used for putting the sticky-note icon on the electronic document (if the result of the judgment in the step S16 is NO), as illustrated in FIG. 12B, an alarm message that alerts the user to use the electronic pen that was used for electronically putting the sticky-note icon on the document is displayed while explicitly showing the authentic electronic pen. However, from the viewpoint of security, it might not be desirable to explicitly show the authentic electronic pen, that is, the electronic pen that was used for electronically putting the sticky-note icon on the document, in response to the tapping of the sticky-note icon with another electronic pen that is not authentic. For this reason, the alarm message may include only information that the electronic pen used for tapping the sticky-note icon does not agree with the electronic pen used for putting the sticky-note icon on the document.

What is claimed is:

1. An information terminal apparatus comprising:
an electronic pen in which a sticky-note management table is stored, the sticky-note management table containing messages and pieces of sticky-note type information, the messages being respectively associated with the pieces of sticky-note type information, each piece of the sticky-note type information indicating a type of sticky-note image; and
a terminal body that includes
a display that displays an image,
a terminal communicating section that acquires the sticky-note management table from the electronic pen,
a management table storing section that stores the acquired sticky-note management table,
a tablet that is operated with the use of the electronic pen, and
a controlling section that reads the messages that are respectively associated with the pieces of sticky-note type information out of the sticky-note management table stored in the management table storing section and causes the display to display the read messages when an operational instruction for electronically putting the sticky-note image on a document displayed on the display is issued from the electronic pen to the tablet.

2. The information terminal apparatus according to claim 1,
wherein the terminal body further includes an icon table in which sticky-note images are memorized in association with the pieces of sticky-note type information; and
the controlling section reads the sticky-note images that are associated with the pieces of sticky-note type information contained in the sticky-note management table stored in the management table storing section out of the icon table and causes the display to display the sticky-note images corresponding to the pieces of sticky-note type information and the associated messages in combination.

3. The information terminal apparatus according to claim 2,
wherein the terminal communicating section further acquires identification information that is unique to the sticky-note management table from the electronic pen; and
when the operational instruction for electronically putting the sticky-note image on a document displayed on the display is issued from the electronic pen to the tablet, and when the type of the sticky-note image that should be put on the document and a location at which the sticky-note image should be put on the document are specified as an instruction issued from the electronic pen to the tablet, the controlling section causes the display to display the specified type of the sticky-note image at the specified location, and in addition, records the identification information acquired by the terminal communicating section, information on the type of the displayed sticky-note image, and a display coordinate of the displayed sticky-note image into the coordinate management table in association with one another.

4. The information terminal apparatus according to claim 3, wherein, when any sticky-note image that is displayed on the display is pointed to with the use of the electronic pen, the controlling section looks up the coordinate management table to identify identification information that corresponds to the pointed sticky-note image and judges whether the identification information acquired by the terminal communicating section agrees with the identification information identified on the basis of the coordinate management table or not.

5. The information terminal apparatus according to claim 4, wherein, in a case where the controlling section judges that the identification information acquired by the terminal communicating section does not agree with the identification information identified on the basis of the coordinate management table, the controlling section causes the display to display a message that indicates disagreement.

6. The information terminal apparatus according to claim 4, wherein, in a case where the controlling section judges that the identification information acquired by the terminal communicating section agrees with the identification information identified on the basis of the coordinate management table, the controlling section causes the display to display a message that is associated with the pointed sticky-note image.
